(19) United States
(12) Patent Application Publication
(10) Pub. No.: US 2015/0067860 A1
(43) Pub. Date: Mar. 5, 2015

(54) Virus Detector Controlled Backup Apparatus and File Restoration

(71) Applicant: BARRACUDA NETWORKS, INC., Campbell, CA (US)

(72) Inventors: ZACHARY LEVOW, CAMUS, WA (US); LINDSAY SNIDER, ANN ARBOR, MI (US)

(73) Assignee: BARRACUDA NETWORKS, INC., Campbell, CA (US)

(21) Appl. No.: 14/013,677

(22) Filed: Aug. 29, 2013

(51) Int. Cl. H04L 29/06

(52) U.S. Cl. CPC H04L 63/145
USPC 726/24

(57) ABSTRACT

A store for virus and malware fingerprints is coupled to a backup server apparatus which receives hashes and file shards from backup clients through a network. A circuit compares hashes received from backup clients to determine matches with file shards previously stored and matches with file shards with virus or malware infections. File shards not previously stored are received for backup and inspection by a virus filter. When a received file shard is determined to match a virus or malware fingerprint, a process is initiated to restore the file on the backup client to a clean version and notify the user and the network security administrator. The hashes of file shards determined to match a virus or malware fingerprint are stored for future reference. The data of a file shard which has been determined to be infected is also stored in case of a false-positive determination.

### RELATED APPLICATIONS

A conventional backup apparatus has been disclosed in U.S. Pat. No. 8,285,997 which issued Sep. 19, 2012. A related currently pending application is Ser. No. 13/246,386 filed Sep. 27, 2011.

### BACKGROUND OF THE INVENTION

A general problem that arises in multi-national organizations is that user owned wireless devices may bring malware in from any place that an employee has traveled. Thus, traditional gateways between local area networks and public wide area networks which protect desktop computers from e-mail and web-based viruses and malware can be by-passed when a traveler returns to the office.

Thus it can be appreciated that what is needed is an automated way of determining what has changed in a mobile wireless device when it connects to a network and removing malware and viruses which infect such a device.

### SUMMARY OF THE INVENTION

User owned wireless devices may bypass anti-virus filters which are deployed at gateways to local area networks when their owners transport them to their desks. The invention uses automated backup systems across an enterprise to inspect and clean mobile wireless devices whenever they are coupled to an internal network or to a cloud service. Each backup server has a store for fingerprints of viruses and malware. The backup server receives hashes and file shards from backup clients. A de-duplication circuit compares the hashes of file shards to determine which file shards have been previously stored. If a file shard has been previously determined to be infected with a virus or malware, the hash of that file shard is annotated. If a file shard has not been previously stored, it is requested from the backup client. Each file shard is stored and its hash is recorded for future use. Each file shard is inspected by a virus/malware filter and their hashes are marked and stored if there is a match with a virus/malware fingerprint. A file restore is initiated to send a previous version of a file which is virus and malware free to the backup client if such a version is on the backup server. In addition to saving the hashes of the virus for future reference, we'll save the data as well and just note it as such in the version history of the file. If someone can determine that there was a false positive determination of infection, the shards at question may be restored.

### BRIEF DESCRIPTION OF DRAWINGS

The present invention will be understood more fully from the detailed description given below and from the accompanying drawings of various embodiments of the invention, which, however, should not be taken to limit the invention to the specific embodiments, but are for explanation and understanding only.

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an exemplary computer system.

FIGS. 2-6 are block diagrams of an apparatus with data flows on communication channels between functional blocks.

FIG. 7 is a flowchart of a method of operation for the instructions which control a processor.

### DETAILED DISCLOSURE OF EMBODIMENTS

An enhanced backup server may be operable as a cloud service or installed within a network of an enterprise. The enhanced backup server can receive and store fingerprints for viruses and malware. The enhanced backup server controls backup and file restoration. A backup agent on the backup client determines file shards and hashes for each file shard. A file shard is defined within this application to be a portion of a file having a maximum size.

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

In the following description, numerous details are set forth. It wall be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the descriptions, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer systems registers and memories into other data similarly represented as physical quantities within the computer system memories or registers or other such non-transitory information storage, communication circuits for transmitting or receiving, or display devices.

The present invention also relates to apparatus for performing the operations herein. This apparatus may be specifically constructed for the required purposes, or it may comprise application specific integrated circuits which are mask programmable or field programmable, or it may comprise a general purpose processor device selectively activated or reconfigured by a computer program comprising executable instructions and data stored in the computer. Such a computer program may be stored in a non-transitory computer readable storage medium, such as, but not limited to, any type of disk including floppy disks, optical disks, CD-ROMs, magnetic-optical disks, solid state disks, flash memory, read-only memories (ROMs), random access memories (RAMs), EPROMS, EEPROMS, magnetic or optical cards, or any type of non-transitory media suitable for storing electronic instructions, and each coupled to a computer system data communication network.

The algorithms and displays presented herein are not inherently related to any particular computer, circuit, or other apparatus. Various configurable circuits and general purpose systems may be used with programs in accordance with the teachings herein, or it may prove convenient to construct more specialized apparatus to perform the required method steps in one or many processors. The required structure for a variety of these systems will be appear from the description below. In addition, the present invention is not described with reference to any particular programming language or operating system environment. It will be appreciated that a variety of programming languages, operating systems, circuits, and virtual machines may be used to implement the teachings of the invention as described herein.

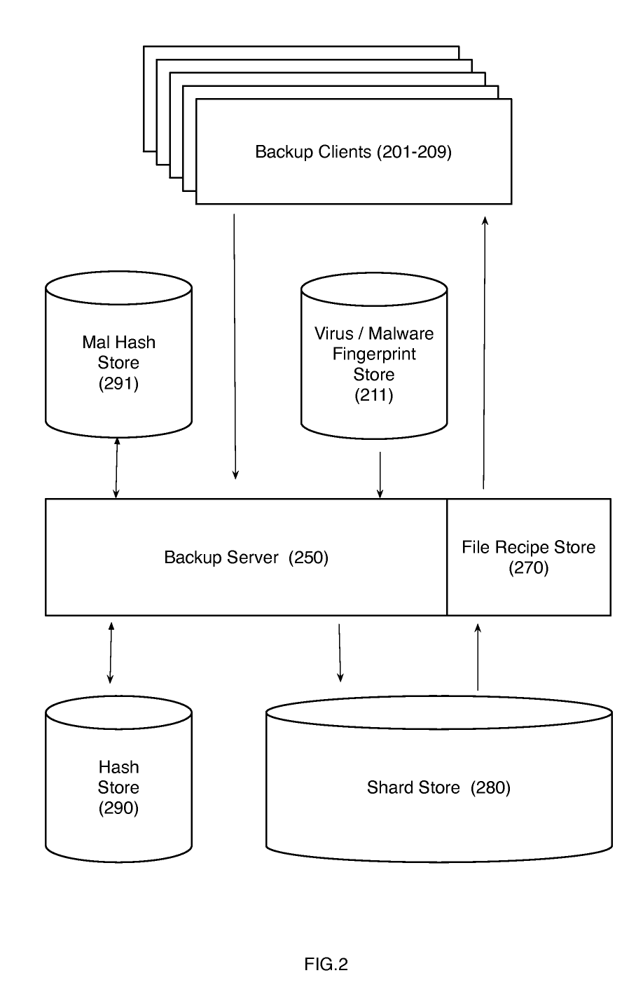

Referring now to FIG. 2, a store for virus and malware fingerprints 211 is coupled to a backup server apparatus 250 which receives hashes and file shards from backup clients through a network. Hashes are computer executed mathematical transforms known in the art such as RFC 3174 SHAT and MD5 but over time, more efficient hashes or combinations of hashes may be embodiments.

The Backup Server 250 is communicatively coupled to several non-transitory computer readable media. A shard store 280 contains portions of files or binary objects of arbitrary size. Each of the stored shards has a corresponding hash in hash store 290. Each version of a file may be reassembled from shards by using recipes in File Recipe Store 270. In an embodiment, the apparatus has a Virus/Malware Fingerprint Store 211. In an embodiment, the apparatus has a Mal Hash Store 291.

A circuit compares hashes received from backup clients to determine matches with file shards previously stored and matches with file shards with virus or malware infections.

If a hash matches the corresponding shard is already stored and it is not necessary to transfer it again. If a hash matches a mal hash, it triggers a file restore to a clean version.

File shards not previously stored are received for backup and inspection by a virus filter.

If a hash does not match, then the shard has never been backed up. The server requests the shard and stores it into Shard Store 280.

When a received file shard is determined to match a virus or malware fingerprint, a process is initiated to restore the file on the backup client to a clean version and notify the user and the network security administrator.

In an embodiment, the hashes of file shards determined to match a virus or malware fingerprint are stored in Mal Hash Store 291 for future reference.

One embodiment of the invention provides a backup system with a malware signature store. Upon recognition of a potential virus or malware infection, the network administrator and the owner of a file is notified of the potential infection and a link is provided to the infected file. If a previous version of the file was stored at the backup server, a restoration is automatically executed to return the file to the last version which was not infected.

In one embodiment, the virus/malware scanning occurs in an apparatus operating in parallel with the backup server. In another embodiment, the virus/malware scanning occurs at the client device prior to chunking/sharding. In another embodiment, the virus/malware scanning occurs after a digital signature has been determined for the file being backed up.

In another embodiment, the binary strings of a virus are used to determine a plurality of signatures and when a backup file has a plurality of matches of binary strings over a threshold, an alert is issued to perform a full signature scan.

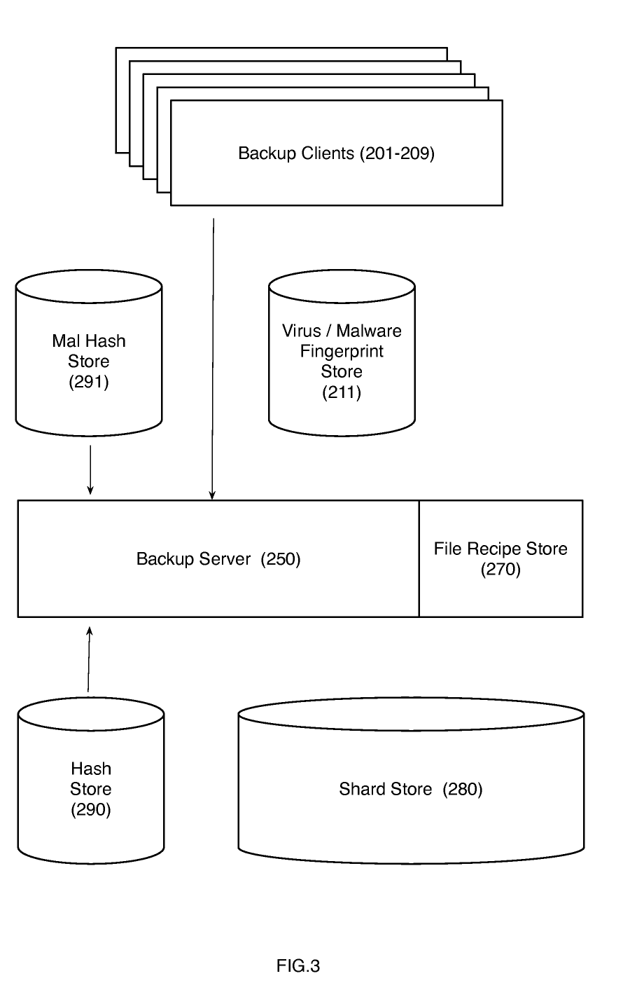

Referring now to FIG. 3, a backup process begins by dividing a file into shards, computing a hash for each shard, and transmitting one or more hashes to the Backup Server 250. The Backup Server reads hashes from Hash Store 290 to determine it is unnecessary to transfer the shard to Shard Store 280. In an embodiment, the Backup Server also reads hashes from Mal Hash Store 291 to determine if it has previously determined that the shard is infected with a virus or malware. There are three possible outcomes: never been seen so a shard transfer is requested, seen before so the shard is already in shard store 280, seen before and determined to contain virus/malware so a file restore is initiated.

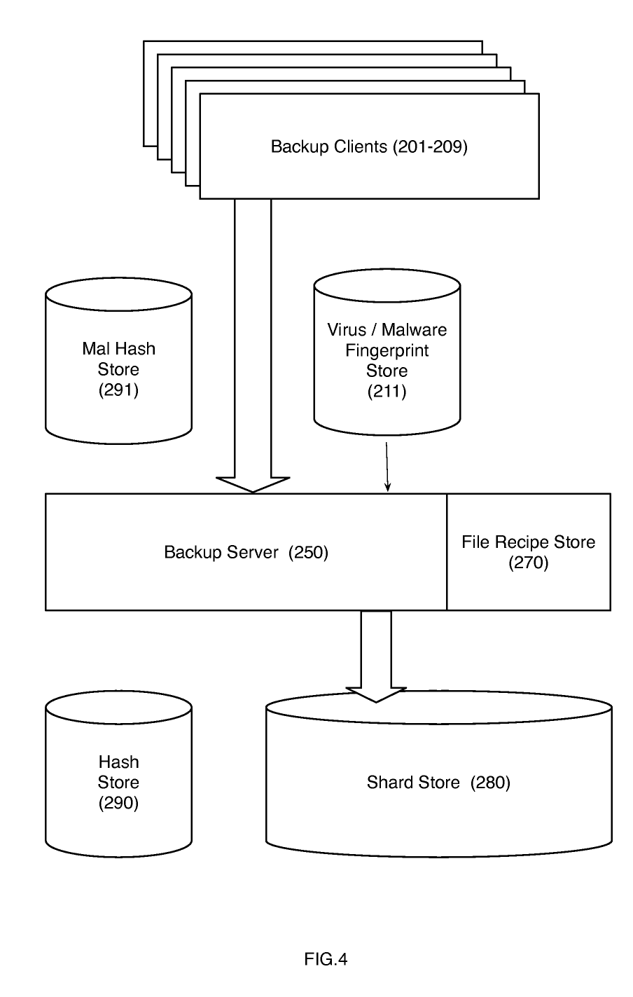

FIG. 4 shows a shard being transferred from backup clients 201-209, compared to virus/malware fingerprints from store 211 and written to Shard Store 280.

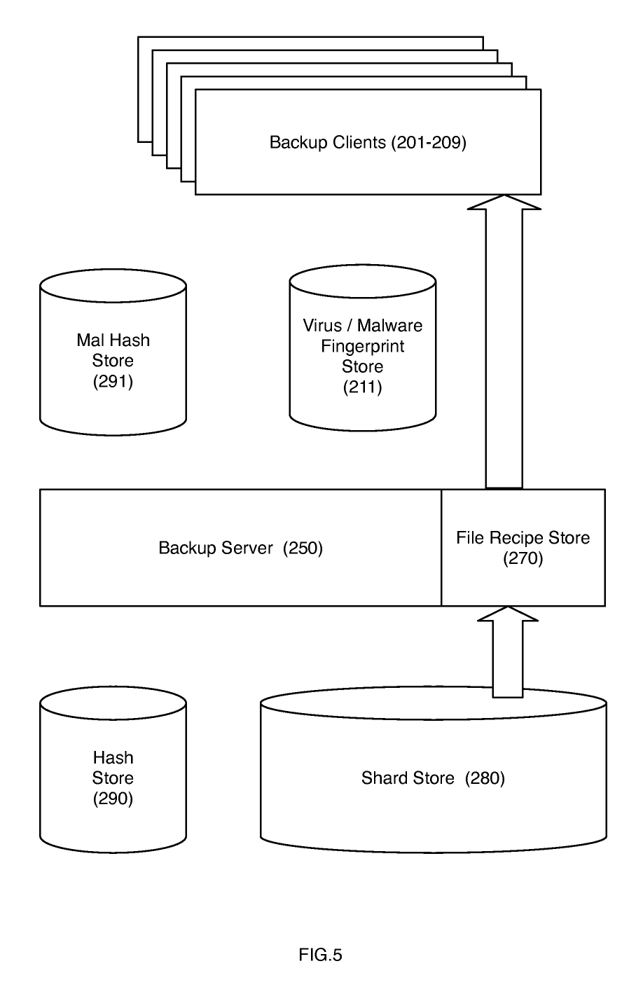

FIG. 5 shows a File Restore to the backup client triggered when a virus or malware is found. The infected file is replaced on the backup client 201-209 by a clean version if the recipe store 270 can reassemble clean shards from shard store 280.

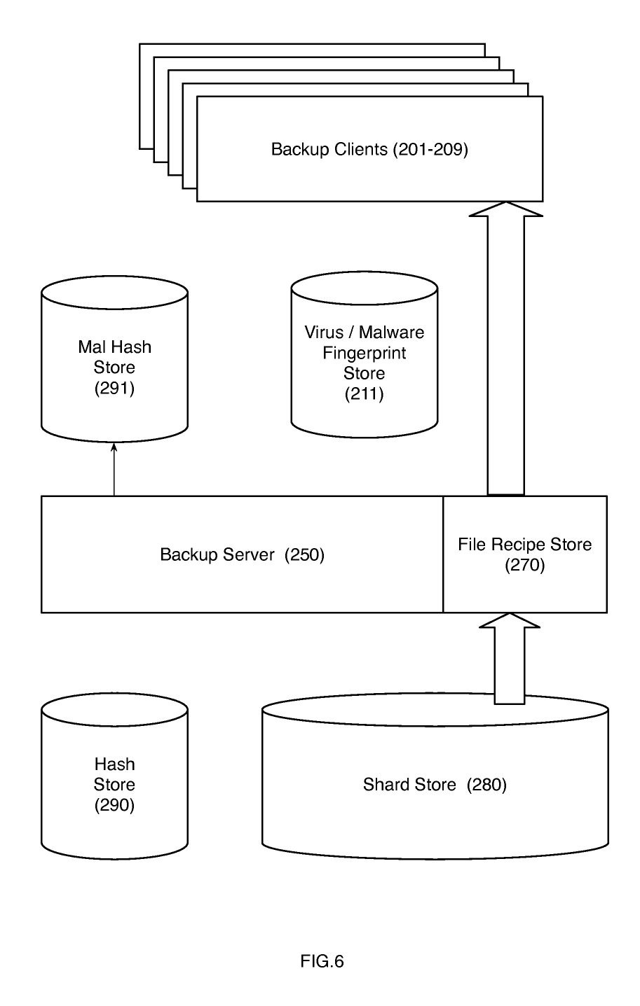

FIG. 6 illustrates an embodiment in which a hash for an infected shard is written to a Mal Hash Store 291. The infected file is replaced on the backup client 201-209 by a clean version if the recipe store can reassemble clean shards.

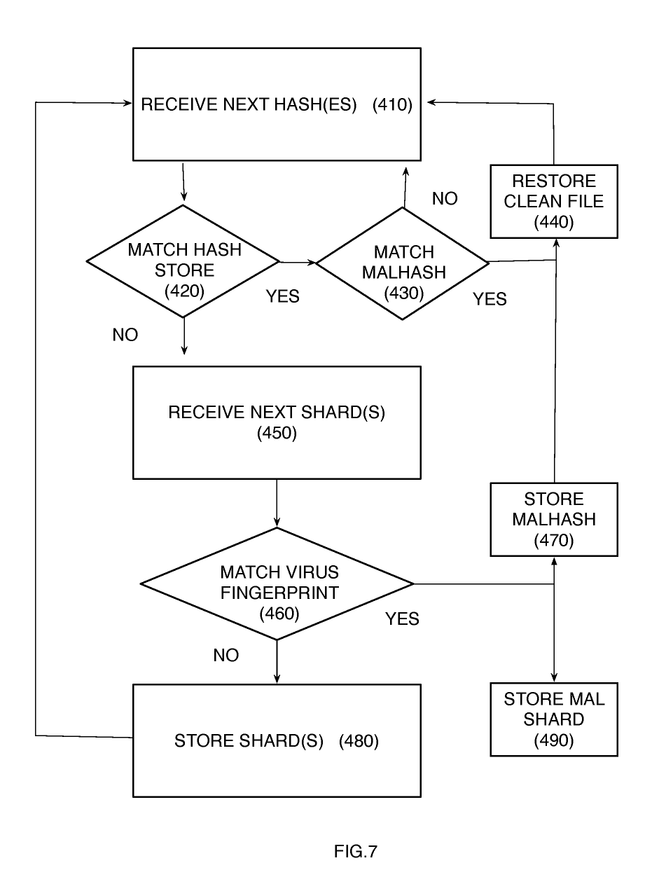

FIG. 7 is a flowchart of a method to control the backup apparatus. The apparatus begins by receiving one or more hashes from a backup client 410. When the hash matches a hash previously stored in hash store it is not necessary to request the shard. In an embodiment, the hash is further compared with hashes in malhash store step 430. If there is a match, it determines that the shard and its file are infected and a restore to a clean file 440 is triggered. When the hash fails to match a hash stored in hash store step 420, the apparatus requests and receives shards step 450. A virus filtering process 460 determines if a shard matches a virus or malware fingerprint. When there is no match, the shard is stored step 480 and the apparatus returns to step 410 for more hashes. When a shard does match a virus or malware fingerprint, it triggers a restore for the file 440 to a clean version (if it can be reassembled using the recipe store). In an embodiment, the hash for the infected shard is stored into malhash store, step 470. In an embodiment, the infected shard is also stored step 490 for the case that the match is a false positive and the latest version is desired. An infection flag for the shard may be set or reset.

One aspect of the invention is an apparatus which has: a store for virus and malware fingerprints is coupled to a backup server apparatus; and the backup server which receives hashes and file shards from backup clients through a network.

In an embodiment, the apparatus also has a circuit to compare hashes received from backup clients to determine matches with file shards both previously stored and previously matched with file shards with virus or malware infections.

An other aspect of the invention is a computer-implemented method for controlling a file backup apparatus, which has the following steps: receiving from a backup client at least one hash for a file shard; comparing a hash received from a backup client with previously stored hashes for previously stored file shards; requesting transmission of a file shard for each hash not previously stored for backup and inspection by a virus filter; and initiating a file restore when a hash matches a file shard previously stored and determined to be infected with a virus or malware.

In an embodiment, the method proceeds, when a received file shard is determined to match a virus or malware fingerprint, initiating a process to restore the file on the backup client to a clean version and notify the user and the network security administrator.

In an embodiment, the method proceeds with storing hashes of file shards determined to match a virus or malware fingerprint are stored for future reference.

The user and a security administrator may be notified when a virus match occurs. The user or security administrator may restore file shards in the event the fingerprint or signature matching circuit suffered a false positive error.

### CONCLUSION

The present invention has two distinct ways to detect viruses and restore files. Each file shard which is part of a file backup is examined for fingerprints of a virus or malware. If found, and if a prior version of the shard is stored at the backup server, the file is automatically restored to the clean version. The hash for that file shard is also marked for future reference. Before file shards are uploaded to the backup server, one or more hashes are determined on the client and transmitted to the backup server. If a hash is marked as having a virus or malware, the file restore process is initiated.

The present invention can be easily distinguished from conventional virus detection systems by automatically restoring a sterile version of the file. In the case of a false positive, the most recent version may be obtained from the backup server. The invention can be easily distinguished by future use of stored hashes of file shards which were previously determined to be infected.

Unlike conventional virus filters, the file does not have to be in transit at a gateway. Unlike conventional anti-virus software, the signature matching does not consume resource at the client device.

In the event of a false positive, the subject file may be retrieved from the backup server.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

### An Exemplary Computer System

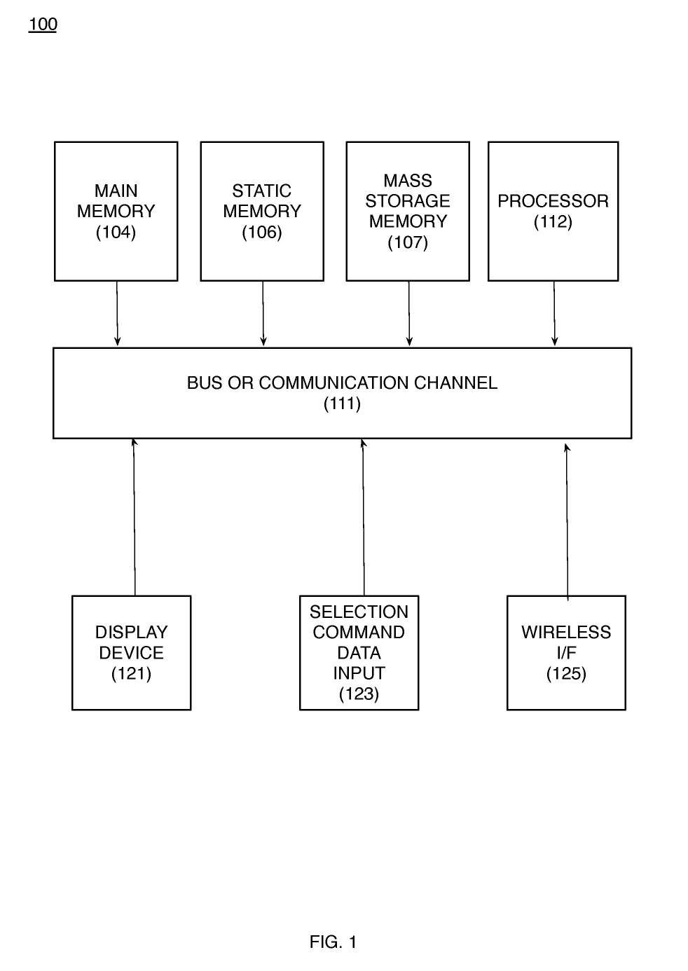

FIG. 1 is a block diagram of an exemplary computer system that may be used to perform one or more of the functions described herein. Referring to FIG. 1, computer system 100 may comprise an exemplary client or server 100 computer system. Computer system 100 comprises a communication mechanism or bus 111 for communicating information, and a processor 112 coupled with bus 111 for processing information. Processor 112 includes a microprocessor, but is not limited to a microprocessor, such as for example, ARM™, Pentium™, etc.

System 100 further comprises a random access memory (RAM), or other dynamic storage device 104 (referred to as main memory) coupled to bus 111 for storing information and instructions to be executed by processor 112. Main memory 104 also may be used for storing temporary variables or other intermediate information during execution of instructions by processor 112.

Computer system 100 also comprises a read only memory (ROM) and/or other static storage device 106 coupled to bus 111 for storing static information and instructions for processor 112, and a non-transitory data storage device 107, such as a magnetic storage device or flash memory and its corresponding control circuits. Data storage device 107 is coupled to bus 111 for storing information and instructions.

Computer system 100 may further be coupled to a display device 121 such a flat panel display, coupled to bus 111 for displaying information to a computer user. Voice recognition, optical sensor, motion sensor, microphone, keyboard, touch screen input, and pointing devices 123 may be attached to bus 111 or a wireless interface 125 for communicating selections and command and data input to processor 112.

Note that any or all of the components of system 100 and associated hardware may be used in the present invention. However, it can be appreciated that other configurations of the computer system may include some or all of the devices in one apparatus, a network, or a distributed cloud of processors.

A number of embodiments of the invention have been described. Nevertheless, it will be understood that various modifications may be made without departing from the spirit and scope of the invention. For example, other network topologies may be used. Accordingly, other embodiments are within the scope of the following claims.

What is claimed is:

1. An apparatus comprising:
a store for virus and malware fingerprints is coupled to a backup server apparatus; and
the backup server which receives hashes and file shards from backup clients through a network.

2. The apparatus of claim 1 further comprising:
a circuit to compare hashes received from backup clients to determine matches with file shards both previously stored and previously matched with file shards with virus or malware infections.

3. A computer-implemented method for controlling a file backup apparatus, the method comprising:
receiving from a backup client at least one hash for a file shard;
comparing a hash received from a backup client with previously stored hashes for previously stored file shards;
requesting transmission of a file shard for each hash not previously stored for backup and inspection by a virus filter; and
initiating a file restore when a hash matches a file shard previously stored and determined to be infected with a virus or malware.

4. The method of claim 3 further comprising:
when a received file shard is determined to match a virus or malware fingerprint,
initiating a process to restore the file on the backup client to a clean version and notify the user and the network security administrator.

5. The method of claim 3 further comprising:
storing hashes of file shards determined to match a virus or malware fingerprint are stored for future reference.
